(19) United States
(12) Patent Application Publication
(10) Pub. No.: US 2007/0266587 A1
(43) Pub. Date: Nov. 22, 2007

(54) Method and apparatus for treating, preferably washing, spinning and/or drying, laundry

(75) Inventors: Wilhelm Bringewatt, Porta Westfalica (DE); Engelbert Heinz, Vlotho (DE)

Correspondence Address: SMITH, GAMBRELL & RUSSELL, SUITE 3100, PROMENADE II, 1230 PEACHTREE STREET, N.E., ATLANTA, GA, 30309-3592, US

(73) Assignee: Herbert Kannegiesser GmbH, Vlotho (DE)

(21) Appl. No.: 11/748,522

(22) Filed: May 15, 2007

(30) Foreign Application Priority Data
May 17, 2006 (DE) 102006023389.1

(51) Int. Cl. F26B 11/02

(52) U.S. Cl. 34/134; 34/596

(57) ABSTRACT

A washer-extractor-dryer (50), in which a plate heat exchanger (60) is arranged in the outer drum (53). During washing, the plate heat exchanger (60) is located in the washing liquid and, as a result, warms the latter up. During drying of the washed laundry, air is conducted along the outside (63) of the plate heat exchanger (60) and is thereby pre-heated before the air enters the inner drum (52) with the laundry to be dried. A pivotable flap (68) is provided in order to allow liquid to flow along the plate heat exchanger (60) during the washing mode and air to flow along it during the drying mode.

### STATEMENT OF RELATED APPLICATION

This patent application is based on and claims convention priority on German Patent Application No. 10 2006 023 389.1 having a filing date of 17 May 2006.

### BACKGROUND OF THE INVENTION

1. Technical Field

The invention relates to a method for treating, preferably for washing, spinning and/or drying, laundry, the laundry being treated in a rotatingly drivable inner drum which is surrounded by an outer drum. The invention furthermore relates to an apparatus for treating, in particular washing, spinning and/or drying, laundry, with an outer drum and an inner drum mounted therein in a rotatingly drivable manner.

2. Prior Art

In commercial launderettes, laundry is treated in washing machines or dryers or combined machines for washing and drying, or washing, spinning and drying. For washing, heated liquid, in particular heated water, is required while hot air is required for drying. In the case of known machines of the type mentioned at the beginning, the liquid required for washing (water) and also air required for drying are heated separately. This requires additional devices for heating the liquid, on the one hand, and the air, on the other hand. In addition to an additional outlay on apparatus, these devices require a large amount of space particularly because they are separate devices.

### BRIEF SUMMARY OF THE INVENTION

Taking the above as the starting point, the invention is based on the object of providing a method and an apparatus for treating, in particular for washing, spinning and/or drying, laundry, with which liquid required for washing (water) and/or air required for drying can be heated in a simple and space-saving manner.

A method for achieving this object is a method for treating laundry, preferably for at least washing laundry, the laundry being treated in a rotatingly drivable inner drum which is surrounded by an outer drum, characterized in that at least one medium for treating the laundry is heated by a heat exchanger which is assigned to the outer drum. According thereto, it is provided to heat at least one medium, such as liquid for washing and/or air for drying the laundry, at least in a heat exchanger which is assigned to the outer drum or forms part of the same. Since, as a result, the heat exchanger or each heat exchanger is integrated into the machine serving to treat the laundry, separate devices for heating the at least one medium, in particular liquid and/or air, are not required. In particular, in the case of machines which serve both for washing and for drying, the same heat exchanger or the same heat exchangers can be used to heat both liquid and air, depending in each case on the laundry treatment to be carried out at the particular moment. The method is suitable particularly for washing machines, washer-extractors, washer-dryers and washer-extractor-dryers, which are referred to collectively below in abbreviated form as “treatment machines”.

In the case of a treatment machine which serves at least for washing and drying, the air is heated by being conducted only along one side of the heat exchanger while liquid is heated by conducting the same along one or, if appropriate, along both sides of the particular heat exchanger. This permits effective heating both of water and liquid in accordance with requirements. In this case, air is fed in from the outside while the liquid located in the outer drum is heated or warmed up.

In a preferred refinement of the method, it is provided to heat the liquid and/or the air by at least one plate heat exchanger preferably arranged in the interior of the outer drum. The arrangement of the plate heat exchanger or of each plate heat exchanger in the interior of the outer drum results in as good as no additional space being required in order to heat the liquid and/or the water because the same plate heat exchanger can be used for heating the liquids and, if appropriate, also the air and is integrated into the treatment machine.

In a particular development of the method, the heating of the liquid and/or air takes place in such a manner that the at least one plate heat exchanger forms part of the wall of the outer drum. Since the inner drum for receiving the laundry to be treated is perforated, the liquid serving for washing and the air serving for drying come into contact with the outer drum and therefore also with the at least one plate heat exchanger which can thus easily dispense the energy supplied to it to the liquid in the interior of the treatment machine and/or to the air.

A particularly effective method is distinguished in that the liquid to be heated and/or the air to be heated is/are conducted along an outside of the plate heat exchanger or of each plate heat exchanger in a manner guided in a targeted manner in at least one flow duct. A targeted flow of the liquid or of the air along a flow duct on the particular plate heat exchanger is therefore produced. The liquid and/or the air is/are thus preferably conducted along the entire outside of the particular plate heat exchanger or at least a large part of the outside, and therefore the energy supplied to the particular plate heat exchanger can be dispensed effectively with a high degree of efficiency to the liquid or the air to be heated.

An apparatus for achieving the object mentioned at the beginning is an apparatus for treating laundry, in particular for at least washing laundry, with an outer drum and an inner drum mounted therein in a rotatingly drivable manner, characterized in that the outer drum is assigned at least one heat exchanger. According thereto, it is provided to arrange at least one heat exchanger in the outer drum of the treatment machine or to assign the outer drum at least one heat exchanger. As a result, liquid for washing and/or air for drying the laundry can be heated or warmed up directly on or in the treatment machine.

According to a preferred refinement of the invention, the at least one heat exchanger is arranged between the outer drum and the inner drum. The respective heat exchanger is therefore located at the point at which the energy is also required, namely in the treatment machine. During washing of the laundry, washing or rinsing liquid is always located in the bottom region of the outer drum. By arranging the at least one heat exchanger in the bottom region of the outer drum, the or each heat exchanger is therefore always located in the treatment liquid in order to efficiently dispense the energy supplied to the respective heat exchanger to the washing liquid. A similar performance occurs when heating air required for drying the laundry.

It is provided, according to a preferred refinement of the invention, to assign the or each heat exchanger to the wall of the outer drum. For example, the respective heat exchanger can be arranged at a small distance on the inside of the wall of the outer drum. However, it is also conceivable that the or each heat exchanger forms at least part of the drum casing of the outer drum.

In order to allow at least part of the liquid or of the air to flow past in a targeted manner on at least one side of the heat exchanger, it is conceivable to provide flow generators, for example pumps, which circulate the liquid or the air and conduct the latter with a continuous flow past the respective heat exchanger. As a result, a particularly good transfer of heat from the heat exchanger medium in the heat exchanger to the liquid or air to be warmed up is obtained when the latter flows past the outside of the heat exchanger.

According to a preferred refinement of the invention, the heat exchanger is designed as at least one plate heat exchanger. Such a plate heat exchanger is compact and can therefore be accommodated in the treatment machine in a space-saving manner.

The or each plate heat exchanger has at least one flow duct for a heat exchanger medium, it being possible for said medium to be, for example, steam, hot oil or another hot liquid.

The respective plate heat exchanger is preferably formed from two plates or metal sheets which are connected to each other in some regions and, in regions which are not connected to each other, are spaced apart in order to form flow ducts for the heat exchanger medium (steam, oil or the like). A plate heat exchanger of this type can be produced in a simple and cost-effective manner. Plate heat exchangers of this type have multiple uses in other fields. They are referred to in technical jargon as cushion plates.

According to a preferred development of the apparatus, it is provided that one side, preferably an outer side, of the respective plate heat exchanger is assigned at least one flow path for liquid to be heated and/or air to be heated. This flow path serves to allow the liquid or the air to flow past the plate heat exchanger, with a transfer of heat from the heat exchanger medium to the liquid and/or air occurring in the interior of the plate heat exchanger and, as a result, the liquid or the air flowing along the respective plate heat exchanger being effectively and uniformly heated.

The at least one flow path along the plate heat exchanger is preferably bounded by a preferably outer plate or metal sheet of the plate heat exchanger and part of the wall of the outer drum. The liquid and/or air in the outer drum is/are therefore heated when the liquid or the air flows along the respective plate heat exchanger and that part of the wall of the outer drum which is assigned thereto.

A development of the invention makes provision for the outer drum to have a bulge in the region of the or each plate heat exchanger. This bulge provides space in order to form at least one flow path of the liquid to be heated or of the air to be heated along, preferably, the outside of the respective plate heat exchanger.

It is furthermore provided that, in the region of the bulge, the or each plate heat exchanger at least partially follows the profile of the outer drum outside the bulge. In the region of the bulge, the respective plate heat exchanger thereby at least in part takes on the function of the outer drum, with the bulge serving to bound the flow path along the outside of the respective plate heat exchanger. The outer drum preferably runs, in the region of the bulge, at a parallel distance to that part of the outer drum which is not assigned a plate heat exchanger. A flow path for liquid to be heated or air to be heated is thus produced with an approximately constant cross section along the outside of the respective plate heat exchanger. As a result, the liquid or the air to be heated flows with an essentially constant velocity along the outside of the respective plate heat exchanger.

In the case of apparatuses which are used both for washing and for drying, i.e., firstly, liquid and, secondly, air is to be heated, it is provided according to the invention to assign the flow path along the or each plate heat exchanger at least one conducting member or shut-off member, in particular to arrange it upstream in the flow direction of the liquid or air. This enables liquid or air to alternatively be fed to the or each plate heat exchanger. The at least one conducting or shut-off member therefore serves, with regard to the type of medium to be preheated or warmed up, to undertake a switching over from the washing mode into the drying mode, and vice versa.

The respective shut-off or conducting member can be adjusted in such a manner that air fed into the outer drum from the outside can be guided along the outside of the respective plate heat exchanger while, alternatively, liquid to be heated can be guided from the outer drum along the outside of the respective plate heat exchanger. The effect thereby achieved in a simple manner is that the liquid located in the outer drum is circulated during or for the warming while the air to be heated flows through the outer drum by, during the drying of the laundry, the moisture absorbed from the air being conducted out of the outer drum and dry air being fed into the outer drum, with the dry air being heated by the respective plate heat exchanger by flowing along the outside of the same.

### BRIEF DESCRIPTION OF THE DRAWINGS

Preferred exemplary embodiments of the invention are explained in more detail below with reference to the drawing, in which:

FIG. 1 shows a schematic cross section through a washing machine.

FIG. 2 shows a schematic cross section through a dryer.

FIG. 3 shows a schematic cross section through a washer-extractor-dryer in the washing mode.

FIG. 4 shows a cross section of the washer-extractor-dryer of FIG. 3 in the drying mode.

### DETAILED DESCRIPTION OF PREFERRED EMBODIMENTS

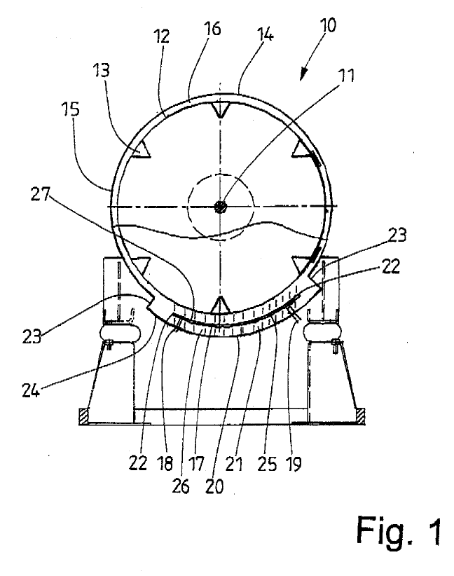

The washing machine 10 illustrated in FIG. 1 is a washing machine for commercial launderettes.

The washing machine 10 has an inner drum 12 which can be driven in a rotating manner about a central axis of rotation 11. The inner drum 12, in particular its cylindrical drum casing, is at least partially perforated and, as a result, is permeable to liquid. In the case of the washing machine 10 shown, a plurality of ribs 13 protruding in the direction of the central axis of rotation 11 are arranged on the inside of the inner drum 12. Said ribs serve to thoroughly mix and to carry along the laundry arranged in the inner drum 12. The washing machine 10 serves to wash any type of laundry (not shown in FIG. 1).

The inner drum 12 is surrounded by a liquid-tight outer drum 14. The outer drum 14 cannot be rotated about the axis of rotation 11. The inner drum 12 therefore rotates within the outer drum 14, which is at a standstill relative to it. The outer drum 14 predominantly has a closed, cylinder-type drum casing 15. The cylindrical drum casing 15 surrounds the cylindrical inner drum 12 concentrically, with the diameter of the outer drum 14 being somewhat larger than that of the inner drum 12, and so a narrow encircling gap 16 is produced between the inner drum 12 and the outer drum 14. The outer drum 14 and the inner drum 12 can be pivoted, if appropriate together, about a horizontal pivot axis which runs transversely with respect to the axis of rotation 11, with it either intersecting the axis of rotation 11 or being located somewhat below the same. The pivot axis and the pivot drive are not shown in FIG. 1. The outer drum 14 and the inner drum 12 can be pivoted by the pivot axis, as a result of which the axis of rotation 11 can be changed in its inclination and, if required, can even be brought into a horizontal position.

The loading and unloading of the washing machine 10 takes place either through an opening in an end side both of the inner drum 12 and of the outer drum 14 or through a closable door in the drum casing 15 of the outer drum 14 and the inner drum 12.

According to the invention, the washing machine 10 is provided with an integrated heat exchanger for warming the washing liquid and, if appropriate, also the rinsing liquid. In the case of the washing machine 10 shown here, the heat exchanger is designed as a single plate heat exchanger 17 although the heat exchanger may also be formed from a plurality of preferably identical plate heat exchangers 17. The plate heat exchanger 17 is designed in the manner of a “cushion plate” in which flow ducts for a heat exchanger medium, for example steam or heated oil, flowing through the plate heat exchanger 17 are provided. The plate heat exchanger 17 can be formed, for example, from two thin plates or metal sheets which are welded around the outer edge and, furthermore, are connected to each other in the region of the surface by a grid of weld points or else weld seams. By subjecting the interior between the metal sheets of the plate heat exchanger 17 to a pressurized liquid, the metal sheets in the regions between the weld points or seams are expanded, as a result of which the metal sheets are permanently spaced apart from one another between the weld points in order to form flow ducts for the heat exchanger medium. In an end or corner region, the plate heat exchanger 17 is provided with a supply line 18 for the heat exchanger medium. At the opposite end or diagonally opposite corner region, the plate heat exchanger 17 has a removal line 19 for the heat exchanger medium. The heat exchanger medium flowing through the plate heat exchanger 17 heats the liquid located in the washing machine 10, preferably washing water and/or rinsing water, in accordance with requirements.

In the case of the washing machine 10 shown here, the plate heat exchanger 17 is arranged in a bulge 20 in the lower region of the outer drum 14. As a result, the plate heat exchanger 17 is located, as it were, immersed in the liquid in the outer drum 14 of the washing machine 10. The plate heat exchanger 17 is thereby essentially completely surrounded by the washing water or rinsing water in the washing machine 10, thus ensuring effective warming of the washing or rinsing water in the outer drum 14 and the inner drum 12. The bulge 20 is formed symmetrically with respect to a vertical central plane running through the axis of rotation 11 and is arranged under the outer drum 14. In the longitudinal direction of the outer drum 14, the bulge 20 preferably runs uninterrupted with an unchanged cross section. However, it is also conceivable for the bulge 20 to extend only over part of the longitudinal direction of the outer drum 14, for example over a central partial region. The bulge 20 is formed by the radius of the outer drum 14 being greater in its region than in the region of the rest of the drum casing 15. As a result, the outer drum 14 is enlarged in the region of the bulge 20 by the drum casing 15 having a larger radius along the lower bulge 20 (with respect to the cross section of the outer drum 14). This gives rise, in the region of the bulge 20, to a relatively large gap 21 between the inner drum 12 and the outer drum 14. The plate heat exchanger 17 is located in the region of this relatively large gap 21. The plate heat exchanger 17 is arched in a curved manner, as seen in the cross-sectional direction of the outer drum 14, to be precise with a radius which corresponds approximately to, and is preferably somewhat larger than, the radius of the outer drum 14 outside the region of the bulge 20. The plate heat exchanger 17, which is arched in a curved manner in the cross-sectional direction, is thus located approximately in the center of the gap 21 between the inner drum 12 and the radius-enlarged, lower part of the drum casing of the outer drum 14 in the region of the bulge 20. In the longitudinal direction of the outer drum 14, i.e. in the direction of the axis of rotation 11, the plate heat exchanger 17 runs rectilinearly at a parallel distance to the axis of rotation 11, with this distance corresponding approximately to or being somewhat larger than the radius of the outer drum 14 outside the region of the bulge 20. As a result, in the case of the washing machine 10 shown here, the plate heat exchanger 17 has a partially cylindrical form.

The base of the plate heat exchanger 17 is smaller than the bulge 20, and therefore, at least as seen in the cross-sectional direction of the washing machine 10, the opposite longitudinal edges 22 of the plate heat exchanger 17 are spaced apart from opposite longitudinal walls 23 of the bulge 20 in order to connect the drum casing 15 to the lower part, of greater radius, of the drum casing in order to form the bulge 20. In the longitudinal direction of the outer drum 14, the plate heat exchanger 17 can run continuously, i.e. from end wall to end wall of the outer drum 14. However, it is also conceivable that the plate heat exchanger 17 is configured to be shorter than the outer drum 14, and therefore those transverse edges of the plate heat exchanger 17 which run in a curved manner and at a distance from opposite end sides of the outer drum 14 end.

Owing to the arrangement of the curved plate heat exchanger 17 between the inner drum 12 and the drum casing section 24 of the outer drum 14, which section is located in the region of the bulge 20 and is enlarged in radius in comparison to the remaining part of the outer drum 14, a continuous flow path 26 is produced on the outside 25 of the plate heat exchanger 17, i.e. between the outer metal sheet of the plate heat exchanger 17 and the drum casing section 24. The liquid to be heated (washing water or rinsing water) can flow along this flow path 26 in the circumferential direction of the outer drum 14 on the plate heat exchanger 17, as a result of which the liquid in the washing machine 10, in particular water, is heated or warmed up by the plate heat exchanger 17. Furthermore, heating or warming up of the water in the washing machine 10 also takes place on the opposite inside 27 of the plate heat exchanger 17. However, this heating up or warming up does not take place by a flow or by a directed flow of the washing water or of the rinsing water along the plate heat exchanger 17. In order to bring about or maintain a correspondingly large flow of water along the flow path 26 between the outside of the plate heat exchanger 17 and the drum casing section 24, the washing machine 10 can have a circulating means (not shown in the figures), for example a pump.

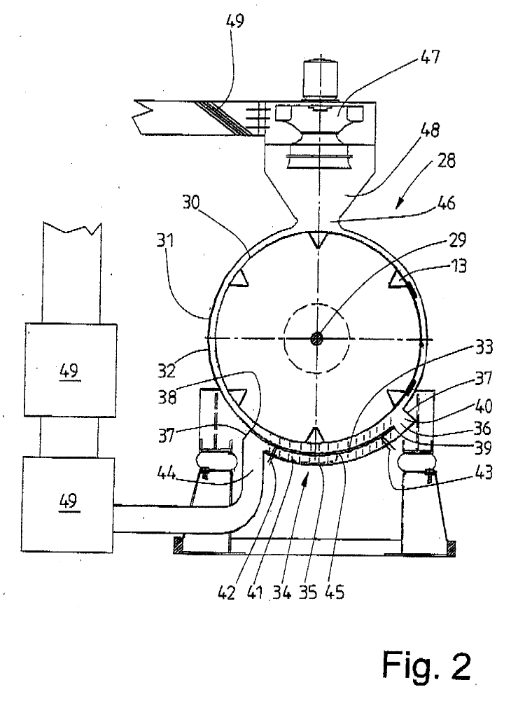

FIG. 2 shows a dryer 28 for commercial launderettes. Said dryer is constructed in principle as the previously described washing machine 10. Reference is made to the detailed explanations of the design which have been given in conjunction with the washing machine 10 insofar as they also apply to the dryer 28. Accordingly, the dryer 28 also has an inner drum 30 which can be driven in a rotating manner about an axis of rotation 29 and is at least partially perforated and is therefore air-permeable. The inner drum 30 is surrounded by a somewhat larger, stationary outer drum 31. The outer drum 31 has an air-tight and largely cylindrical drum casing 32. In particular for loading and unloading the dryer 28, a horizontal pivot axis, which intersects the axis of rotation 29 at right angles, can be provided with a pivot drive (not shown), as a result of which the inclination of the axis of rotation 29 of the inner drum 30 and of the outer drum 31 can be changed. The loading and unloading of the dryer 28 takes place either through an end side of the inner drum 30 and of the outer drum 31 or through a closable door in the casing of the inner drum 30 and of the outer drum 31.

Also in the case of the dryer 28, the outer drum 31 is assigned a heat exchanger. In the exemplary embodiment shown, the latter is designed as a single plate heat exchanger 33. The design, the operation and the construction of the plate heat exchanger 33 correspond to the plate heat exchanger 17 of the washing machine 10 described previously. The plate heat exchanger 33 is also arranged in the region of a bulge 34 in the lower region of the outer drum 31. As seen in the cross section of the dryer 28, the radius of the outer drum 31 is enlarged in the region of the bulge 34 in order to form the same, and therefore a drum casing section 35 in the region of the bulge 34 is further away from the casing of the inner drum 30 than the remaining region of the drum casing 32 of the outer drum 31. As a result, a relatively wide gap 36 in comparison to the remaining part of the drum casing 32 of the outer drum 31, which part is smaller in radius, is produced between the inner drum 31 and the drum casing section 35 in the region of the bulge 34. By means of longitudinal walls 37, the drum casing section 35 which is larger in radius is connected at opposite ends of the bulge 34 (cross section) to the drum casing 32 of the outer drum 31 that is smaller in radius.

The plate heat exchanger 33 is located approximately in the center of the wide gap 36 between the drum casing section 35 of the bulge 34 and the inner drum 30. Accordingly, the plate heat exchanger 33 is of circular design in cross section, with the radius in the region of the plate heat exchanger 33 approximately corresponding to or being somewhat larger than the radius of the outer drum 31 outside the region of the bulge 34. The plate heat exchanger 33 is connected at a longitudinal edge 38 (on the left in FIG. 2) to the drum casing 32 of the outer drum 31 in a hermetically sealed manner, to be precise at the point where the longitudinal wall 37 adjoins the drum casing 32 of the outer drum 31 at one end of the bulge 34. As a result, the plate heat exchanger 33 forms part of the outer drum 31, in particular part of the drum casing 32 of the same. An opposite longitudinal edge 39 of the plate heat exchanger 33 ends at a distance in front of the longitudinal wall 37 of the bulge 34. An overflow duct 40 which leads into the interior of the dryer 28 towards the inner drum 30 is thereby produced at the end of the flow path 41 between the outside 45 of the plate heat exchanger 33 and the drum casing section 35 of the bulge 34.

In order to supply a heat exchanger medium to the plate heat exchanger 33 and in order to remove the heat exchanger medium, the plate heat exchanger 33 is provided with a supply line 42 and a removal line 43.

In the case of the dryer 28 shown, the air to be heated in order to dry the laundry is guided in an open circuit. Accordingly, the air to be heated, which can be cold fresh air, is conducted through an air supply duct 44 to the outside of the plate heat exchanger 33. The air supply duct 44 opens into the bulge 34, to be precise at that end (on the left in FIG. 2) at which the longitudinal edge 38 of the plate heat exchanger 33 is connected to the drum casing 32 of the outer drum 31 in a hermetically sealed manner. The air fed into the dryer 28 from the air supply duct 44 thus enters the flow path 41. The air flows through the flow path 41 along the outside 45 of the plate heat exchanger 33, as a result of which it is heated by the plate heat exchanger 33, namely by the heat exchanger medium flowing through the same. At the end of the flow path 41, the air passes via the overflow duct 40 past the free end of the plate heat exchanger 33 into the interior of the dryer 28, namely to the inner drum 30 and through the perforated inner drum 30 to the laundry to be dried in the inner drum 30.

In the case of the dryer 28, the outer drum 31 is provided on the upper side with an opening 46 through which air which has become moist during drying of the laundry can be removed. In the exemplary embodiment shown, moist air is sucked out of the dryer 28 as exhaust air by a ventilator 47 and is removed via an exhaust air line 48. The moist exhaust air can be guided into the open air via the exhaust air line 48. However, it is also conceivable to conduct the moist air via the exhaust air line 48 to a dehumidifier and to conduct dehumidified air, as reusable drying air, along the plate heat exchanger 33 via the air supply duct 44 back into the interior of the dryer 28. The air is then guided in the closed circuit through the dryer 28 in order to dry the laundry.

The additional air to be heated for the dryer 28, in particular if it is recirculated air, is filtered by at least one filter 49. The filter 49 serves in particular to remove lint from the air, said lint accumulating in the air when the lint is circulated by dehumidified air being conducted again into the dryer 28.

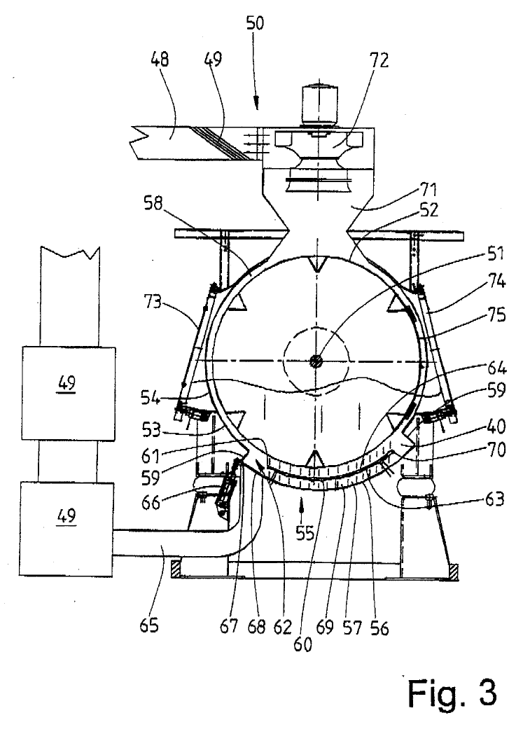

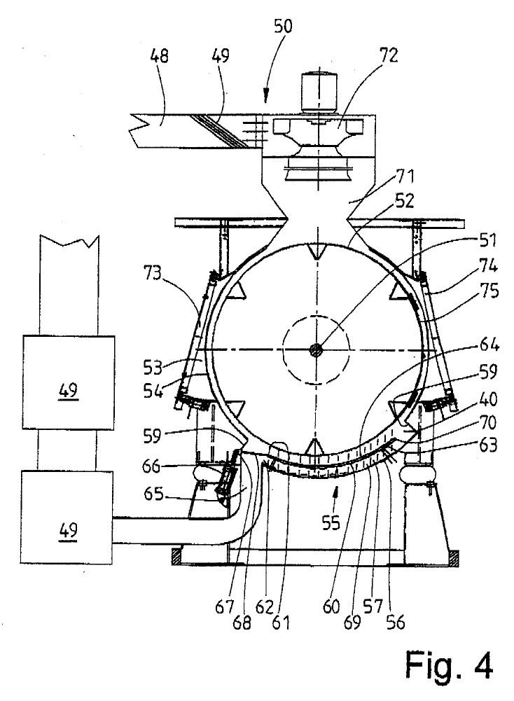

FIGS. 3 and 4 show a washer-extractor-dryer 50. This is in principle designed in exactly the same manner as the washing machine 10 and the dryer 28. Accordingly, the washer-extractor-dryer 50 also has an inner drum 52 which can be driven in a rotating manner about an axis of rotation 51, is at least partially perforated and is therefore water- and air-permeable. The essentially cylindrical inner drum 52 is surrounded by a relatively large outer drum 53 with an essentially cylindrical drum casing 54. The lower region of the outer drum 53 is assigned a bulge 55. The bulge 55 is bounded in the circumferential direction by a drum casing section 56 which runs at a parallel distance to the cylindrical casing of the inner drum 52. The radius of the drum casing section 56 is larger than the radius of the drum casing 54 of the outer drum 53. In the region of the bulge 55, a wide gap 57 is thus produced between the drum casing section 56 and the inner drum 52, which gap is approximately twice as wide as the gap 58 between the drum casing 54 of the outer drum 53 and the inner drum 52. Opposite ends of the bulge 55 are also bounded here by radially directed longitudinal walls 59.

The heat exchanger, which is formed here by a single plate heat exchanger 60, is arranged approximately centrally in the wide gap 57. The plate heat exchanger 60 is designed in the same manner as the plate heat exchanger 17 of the washing machine 10. Reference is therefore made in respect of the details of the plate heat exchanger 60 to the description for the plate heat exchanger 17. Opposite longitudinal edges 61 of the plate heat exchanger 60 end in each case at a distance in front of the longitudinal walls 59 of the bulge 55. As a result, overflow ducts 62 are produced on both sides of the plate heat exchanger 60 between the outside 63 and the inside 64 of the plate heat exchanger 60.

The washer-extractor-dryer 50 differs from the washing machine 10 and from the dryer 28 by a conducting or shut-off member being arranged at the point at which an air supply duct 65, as in the case of the dryer 28, leads into an end region of the #1000948 bulge 55. In the exemplary embodiment shown, the conducting and shut-off member is designed as a flap 68 which can be pivoted about a pivot axis 67 by a pressure medium cylinder 66. The horizontal pivot axis 67 of the flap 68 is located at the corner between the drum casing section 56 and a longitudinal wall 59 of the bulge 55. The flap 68 can be pivoted by the pressure medium cylinder 66 into the different positions shown in FIGS. 3 and 4. FIG. 3 shows a position of the flap 68 for the washing mode of the washer-extractor-dryer 50. In this position, the flap 68 closes the air supply duct 65 and therefore also the bulge 55 of the outer drum 53. Washing or rinsing liquid can thus flow through the overflow duct 62 above the flap 68 to the outside 63 of the plate heat exchanger 60. The washing or rinsing liquid then flows along the flow path 69 along the rear side of the plate heat exchanger 60 and through the overflow duct 62 at the opposite end of the plate heat exchanger 60 back into the gap 58 between the outer drum 53 and the inner drum 52. In the dryer mode of the washer-extractor-dryer 50 (FIG. 4), the pressure medium cylinder 66 pivots the flap 68 in the anticlockwise direction in such a manner that a free end 70 of the flap 68 bears in a sealing manner against the corresponding longitudinal edge 61 of the plate heat exchanger 60. As a result, the air, in particular fresh air, fed into the washer-extractor-dryer 50 by the overflow duct 62 is conducted to the outside 63 of the plate heat exchanger 60 along the flow path 69. At the opposite longitudinal edge 61 (on the right in FIGS. 3 and 4) of the plate heat exchanger 60, the air passes via the overflow duct 6.2 to the inner drum 52.

The switching over of the washer-extractor-dryer 50 from the washing mode to the dryer mode and vice versa can also take place by means of different conducting or shut-off members, for example slides or else valves.

On the upper side of the outer drum 53, the washer-extractor-dryer 50 has a connection for an exhaust air line 71 which is assigned a ventilator 72 or the like. The functions of the ventilator 72 and of the exhaust air line 71 correspond to that of the dryer 28. In this respect, reference is made to the description for the dryer 28.

The washer-extractor-dryer 50 shown in FIGS. 3 and 4 involves a “partition design”, i.e. the washer-extractor-dryer 50 is arranged between an unclean space and a clean space. Accordingly, the loading of the washer-extractor-dryer 50 takes place from a different location than the unloading. For the loading, the outer drum 53 is assigned a closable door 73 on the “unclean” side. The door 73 is arranged in a partition (not illustrated in FIGS. 3 and 4). A further door 74 is arranged on that side of the washer-extractor-dryer 50 which is located opposite the door 73. This door 74 is also installed in a partition (not shown). The door 74 closes the “clean” side of a launderette. In this manner, washed, if appropriate spin-dried and dried clean laundry can pass through the door 74 to the clean side of the launderette while dirty laundry, which is possibly contaminated, is separated from clean laundry before the opposite door 73. The washer-extractor-dryer 50 shown also has a closable, joint loading and unloading opening 75 in the outer drum 53 and the inner drum 52. Said opening is brought into the region of the door 73 closing the unclean side in order to load the washer-extractor-dryer 50. In order to remove clean laundry, the loading and unloading opening 75 is brought approximately into overlap with the door 74 pointing to the clean side.

The invention is also suitable for washer-extractor-dryers which are not arranged in the partition region, and so—as in the case of the washing machine 10 and the dryer 28 (FIGS. 1 and 2)—doors 73 and 74 arranged in partitions are not provided. The loading and unloading of such a washer-extractor-dryer not provided for the partition operation then takes place directly via the loading and unloading opening 75, with it being possible for the loading and unloading to take place, if appropriate, in the same position of the closable loading and unloading opening 75.

A washer dryer which only washes and dries the laundry but does not spin-dry it can also be designed in precisely the same manner as the washer-extractor-dryer 50 described above.

The previously described exemplary embodiments of the invention concern a washing machine 10, a dryer 28 and a washer-extractor-dryer 50 with a drum which has only one treatment chamber. However, the invention may also be used in other types of washing machines, dryers and washer-extractor-dryers or washer dryers, for example those which have an elongated drum with a plurality of successive chambers, as is the case, for example, in continuous-flow washing machines.

List of reference numbers:

| | |
|---|---|
| 10 | Washing machine |
| 11 | Axis of rotation |
| 12 | Inner drum |
| 13 | Rib |
| 14 | Outer drum |
| 15 | Drum casing |
| 16 | Gap |
| 17 | Plate heat exchanger |
| 18 | Supply line |
| 19 | Removal line |
| 20 | Bulge |
| 21 | Gap |
| 22 | Longitudinal edge |
| 23 | Longitudinal wall |
| 24 | Drum casing section |
| 25 | Outside |
| 26 | Flow path |
| 27 | Inside |
| 28 | Dryer |
| 29 | Axis of rotation |
| 30 | Inner drum |
| 31 | Outer drum |
| 32 | Drum casing |
| 33 | Plate heat exchanger |
| 34 | Bulge |
| 35 | Drum casing section |
| 36 | Widegap |
| 37 | Longitudinal wall |
| 38 | Longitudinal edge |
| 39 | Longitudinal edge |
| 40 | Overflow duct |
| 41 | Flow path |
| 42 | Supply line |
| 43 | Removal line |
| 44 | Air supply duct |
| 45 | Outside |
| 46 | Opening |
| 47 | Ventilator |
| 48 | Exhaust air line |
| 49 | Filter |
| 50 | Washer-extractor-dryer |
| 51 | Axis of rotation |
| 52 | Inner drum |
| 53 | Outer drum |
| 54 | Drum casing |
| 55 | Bulge |
| 56 | Drum casing section |
| 57 | Wide gap |
| 58 | Gap |
| 59 | Longitudinal wall |
| 60 | Plate heat exchanger |
| 61 | Longitudinal edge |
| 62 | Overflow duct |
| 63 | Outside |
| 64 | Inside |
| 65 | Air supply duct |
| 66 | Pressure medium cylinder |
| 67 | Pivot axis |
| 68 | Flap |
| 69 | Flow path |
| 70 | Free end |
| 71 | Exhaust air line |
| 72 | Ventilator |
| 73 | Door |
| 74 | Door |
| 75 | Loading and unloading opening |

What is claimed is:

1. A method for treating laundry, the laundry being treated in a rotatingly drivable inner drum (12, 30, 52) which is surrounded by an outer drum (14, 31, 53), wherein at least one medium for treating the laundry is heated by a heat exchanger which is assigned to the outer drum (14, 31, 53).

2. The method according to claim 1, wherein the at least one medium to be heated is conducted along one side of the heat exchanger.

3. The method according to claim 1, wherein the at least one medium is air fed in from the outside and guided along one side of the heat exchanger.

4. The method according to claim 3, wherein a liquid medium to be heated is conducted along the same side of the heat exchanger along which the air.

5. The method according to claim 4, wherein the liquid to be heated is conducted along both sides of the heat exchanger.

6. The method according to claim 1, wherein liquid located in the outer drum is heated.

7. The method according to claim 1, wherein the at least one medium is heated by at least one plate heat exchanger (17, 33, 60) in the outer drum (14, 31, 53).

8. The method according to claim 1, wherein the at least one medium is heated by at least one plate heat exchanger (17, 33, 60) in the region of a casing of the outer drum (14, 31, 53).

9. The method according to claim 8, wherein the at least one medium is heated by at least one plate heat exchanger (17, 33, 60) forming at least part of the wall of the outer drum (14, 31, 53).

10. An apparatus for treating laundry, comprising an outer drum (14, 31, 53) and an inner drum (12, 30, 52) mounted in the outer drum in a rotatingly drivable manner, wherein the outer drum (14, 31, 53) is assigned at least one heat exchanger.

11. The apparatus according claim 10, wherein the heat exchanger is arranged in the outer drum (14, 31, 53)

12. The apparatus according to claim 11, wherein the at least one heat exchanger is arranged between the outer drum (14, 31, 53) and the inner drum (12, 30, 52).

13. The apparatus according to claim 10, wherein the at least one heat exchanger is assigned to a wall of the outer drum (14, 31, 53).

14. The apparatus according to claim 13, wherein the at least one heat exchanger forms part of the wall of the outer drum (14, 31, 53).

15. The apparatus according to claim 10, wherein the heat exchanger is formed from at least one plate heat exchanger (17, 33, 60).

16. The apparatus according to claim 15, wherein the plate heat exchanger (17, 33, 60) comprises at least one flow duct for a heat exchanger medium.

17. The apparatus according to claim 16, wherein the at least one plate heat exchanger (17, 33, 60) is formed from two plates which are connected to each other in some regions and, in regions which are not connected to each other, are spaced apart from each other in order to form the at least one flow duct.

18. The apparatus according to claim 15, wherein one side of the respective plate heat exchanger (17, 33, 60) is assigned at least one flow path (26, 41, 69) for the at least one medium to be heated.

19. The apparatus according to claim 18, wherein the at least one flow path (26, 41, 69) is bounded by the respective plate heat exchanger (17, 33, 60) and part of a wall of the outer drum (14, 31, 53)

20. The apparatus according to claim 15, wherein the outer drum (14, 31, 53) comprises a bulge (20, 34, 55) in the region of the at least one plate heat exchanger (17, 33, 60).

21. The apparatus according to claim 20, wherein, in the region of the bulge (20, 34, 55), the at least one plate heat exchanger (17, 33, 60) at least partially follows the profile of the outer drum (14, 31, 53) outside the region of the bulge (20, 34, 55) of the outer drum (14, 31, 53).

22. The apparatus according to claim 20, wherein the bulge (20, 34, 55) is formed by an outer offset of a wall of the outer drum (14, 31, 53), the wall of the outer drum (14, 31, 53) running, in the region of the bulge (20, 34, 55), at a parallel distance to the at least one plate heat exchanger (17, 33, 60).

23. The apparatus according to claim 18, further comprising at least one conducting member assigned to the flow path (26, 41, 69) along the at least one plate heat exchanger (17, 33, 60)

24. The apparatus according to claim 23, wherein the at least one conducting member is designed for optionally guiding air or liquid at least along the outside (25, 45, 63) of the at least one plate heat exchanger (17, 33, 60).

25. The apparatus according to claim 23, wherein the at least one conducting member can be adjusted in such a manner that, firstly, air fed into the outer drum (14, 31, 53) from the outside can be guided along the outside (25, 45, 63) of the plate heat exchanger (17, 33, 60) while, secondly, liquid to be heated up can be guided from the outer drum (14, 31, 53) along the outside (25, 45, 63) of the plate heat exchanger (17, 33, 60).

26. The apparatus according to claim 18, wherein the flow path (26, 49, 69) along the at least one plate heat exchanger (17, 33, 60) is assigned at least one shut-off member.

27. The apparatus according to claim 26, further comprising at least one shut-off member is designed for optionally guiding air or liquid at least along the outside (25, 45, 63) of the at least one plate heat exchanger (17, 33, 60).
